(19) United States
(12) Patent Application Publication
(10) Pub. No.: US 2022/0318870 A1
(43) Pub. Date: Oct. 6, 2022

(54) NEGOTIATION SYSTEM, NEGOTIATION METHOD, AND NEGOTIATION PROGRAM

(71) Applicant: NEC Corporation, Minato-ku, Tokyo (JP)

(72) Inventors: Tomohito ANDO, Tokyo (JP); Shiniji NAKADAI, Tokyo (JP); Satoshi MORINAGA, Tokyo (JP)

(73) Assignee: NEC Corporation, Minato-ku, Tokyo (JP)

(21) Appl. No.: 17/633,637

(22) PCT Filed: Aug. 23, 2019
(86) PCT No.: PCT/JP2019/033018

§ 371 Date: Feb. 8, 2022

(51) Int. Cl. G06Q 30/06; G06Q 10/08

(52) U.S. Cl. CPC G06Q 30/0611; G06Q 30/0617; G06Q 10/083

(57) ABSTRACT

A negotiation system 20 for negotiating with an order-placing side who presents, to an order-receiving side that provides any product or service, an order that represents a request for provision of the any product or service, includes: a determination unit 21 which determines whether execution conditions according to an existing order from the order-placing side can be changed; a planning unit 22 which prepares an order-receiving plan for execution conditions according to a new order from the order-placing side and execution conditions according to the existing order after changing of an execution condition determined to be changeable; and a utility computation unit 23 which computes a utility based on the order-receiving plan.

### TECHNICAL FIELD

The present invention relates to a negotiation system, a negotiation method, and a negotiation program for automatically conducting negotiations for adjusting conditions between an order-placing side and an order-receiving side.

### BACKGROUND ART

In recent years, an international competition called ANAC (Automated Negotiating Agents Competition) has been held at a prestigious international conference, and expectations for automatic negotiation agent technology are increasing. An automated negotiating agent is a technology that automates negotiations conducted by humans, and uses AI (Artificial Intelligence) to generate draft agreement conditions and determine acceptance or rejection, and various methods for realizing this have been proposed.

Patent literature (PTL) 1 describes an automatic negotiation system that performs automatic negotiations with other systems. The automatic negotiation system described in PTL 1 determine target candidates in automatic negotiations from a total result of a demand utility function that represents a change in a profit and loss of a supplier with respect to a change in a demand amount of a consumer from a standard, and a supply utility function represents a change in a profit and loss of a supplier with respect to a change in an aggregate demand amount from a standard.

In addition, PTL 2 describes a quotation response method that accepts and automatically responds to quotation requests through the Internet or the like. In the method described in PTL 2, a quotation DB (database) which is a basis of price quotation and a correction DB which can change the setting contents according to the timing of product development requested by the quotation are maintained, and when an opportunity summary and requirement specifications are submitted by a user, a quotation is generated, and a price and a delivery date are corrected for the generated quotation.

### CITATION LIST

### Patent Literature

PTL 1: International Publication No. WO 2018/070419

PTL 2: Japanese Patent Application Laid-Open No. 2008-015892

### SUMMARY OF INVENTION

### Technical Problem

On the other hand, when negotiating between the order-placing side and the order-receiving side to adjust conditions such as a delivery date, a quantity, a price, etc., the order-receiving side needs to judge whether the conditions presented by the order-placing side are acceptable based on information such as its own production capacity and production plan.

When negotiating, the order-receiving side expects to be able to receive an order with a higher value. In other words, the order-receiving side seeks an automatic negotiation agent that can compare the value of an existing order with the value of a new order, and negotiate with the order-placing side so that the order with higher value can be received. PTLs 1-2 do not describe any technology that provides the order-receiving side with an opportunity to be able to receive a higher-value order.

Therefore, it is an object of the present invention to provide a negotiation system, a negotiation method, and a negotiation program capable of providing the order-receiving side with an opportunity to receive a higher value order.

### SOLUTION TO PROBLEM

A negotiation system according to the present invention is a negotiation system for negotiating with an order-placing side who presents, to an order-receiving side that provides any product or service, an order that represents a request for provision of the any product or service, includes a determination unit which determines whether execution conditions according to an existing order from the order-placing side can be changed, a planning unit which prepares an order-receiving plan for execution conditions according to a new order from the order-placing side and execution conditions according to the existing order after changing of an execution condition determined to be changeable, and a utility computation unit which computes a utility based on the order-receiving plan.

A negotiation method according to the present invention is a negotiation method implemented by a negotiation system for negotiating with an order-placing side who presents, to an order-receiving side that provides any product or service, an order that represents a request for provision of the any product or service, includes determining whether execution conditions according to an existing order from the order-placing side can be changed, preparing an order-receiving plan for execution conditions according to a new order from the order-placing side and execution conditions according to the existing order after changing of an execution condition determined to be changeable, and computing a utility based on the order-receiving plan.

A negotiation program according to the present invention, causing a computer to execute a determination process of determining whether execution conditions according to an existing order from an order-placing side that represents a request for provision of any product or service to an order-receiving side that provides the any product or service can be changed, a preparing process of preparing an order-receiving plan for execution conditions according to a new order from the order-placing side and execution conditions according to the existing order after changing of an execution condition determined to be changeable, and a computation process of computing a utility based on the order-receiving plan.

### ADVANTAGEOUS EFFECTS OF INVENTION

According to the present invention, it is possible to provide the order-receiving side with an opportunity to receive a higher value order.

### BRIEF DESCRIPTION OF DRAWINGS

FIG. 1 is a block diagram showing an example of the configuration of an example embodiment of a negotiation system according to the present invention.

FIG. 2 is an explanatory diagram showing an example of a parameter file.

FIG. 3 is an explanatory diagram showing an example of BOM/BOP.

FIG. 4 is an explanatory diagram showing an example of the setup change time.

FIG. 5 is an explanatory diagram showing an example of displaying a negotiation candidate.

FIG. 6 is an explanatory diagram showing an example of a screen for entering a negotiation condition.

FIG. 7 is a flowchart showing an example of the operation by an automatic negotiation system.

FIG. 8 is a block diagram showing an overview of the negotiation system according to the present invention.

### DESCRIPTION OF EMBODIMENTS

Hereinafter, an example embodiment of the present invention is described with reference to the drawings.

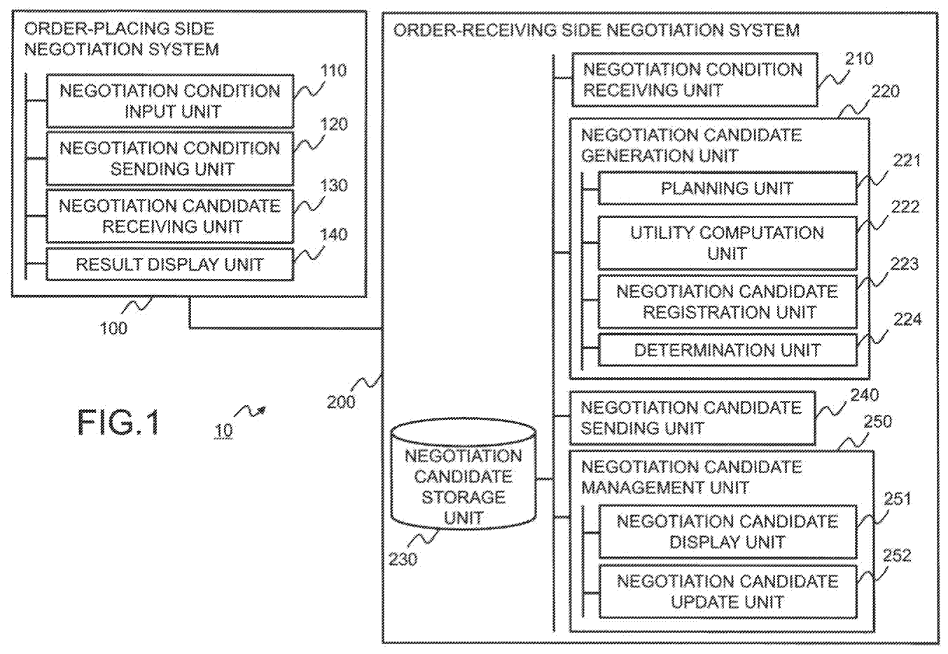

FIG. 1 is a block diagram showing an example of the configuration of an example embodiment of a negotiation system according to the present invention. The automated negotiation system 10 illustrated in FIG. 1 includes an order-placing side negotiation system 100 and an order-receiving side negotiation system 200.

The order-placing side negotiation system 100 is a system for an entity side that presents an order representing a request for provision of any products or services (hereinafter simply referred to as the order-placing side) to negotiate conditions for placing an order with an entity side that provides any products or services (hereinafter simply referred to as the order-receiving side). On the other hand, the order-receiving side negotiation system 200 is a system for presenting negotiation candidates based on the negotiation conditions presented by the order-placing side, taking into consideration the conditions for receiving an order and the like. In this example embodiment of the order-receiving side negotiation system 200, negotiation candidates (candidates for a negotiation solution) are generated in batch processing at the order-receiving side, and negotiation with the order-placing side is performed based on the generated negotiation candidate at the time of negotiation.

In addition, the order-receiving side negotiation system 200 of this example embodiment provides the order-receiving side with an opportunity to receive orders of relatively high value by reducing the priority for orders of relatively low value.

The order-receiving side negotiation system 200 includes a negotiation condition receiving unit 210, a negotiation candidate generation unit 220, a negotiation candidate storage unit 230, a negotiation candidate sending unit 240, and a negotiation candidate management unit 250.

The negotiation condition receiving unit 210 receives negotiation conditions of the order-placing side from the order-placing side negotiation system 100. In this example embodiment, receiving the negotiation conditions of the order-placing side corresponds to receiving an order from the order-placing side. The negotiation conditions include requests of the order-placing side such as delivery date and cost.

The negotiation candidate generation unit 220 generates negotiation candidates of the order-receiving side for an order from the order-placing side and stores it in the negotiation candidate storage unit 230 described below. The order from the order-placing side can be defined as a set of conditions representing a demand of the order-placing side. The negotiation candidate generation unit 220 includes a planning unit 221, a utility computation unit 222, a negotiation candidate registration unit 223, and a determination unit 224.

The planning unit 221 prepares an order-receiving plan for execution conditions according to an order from the order-placing side. The order from the order-placing side corresponds to the execution conditions required by the order-receiving side.

Then, the planning unit 221 generates a plurality of execution conditions based on the order according to the following method, and prepares an order-receiving plan for the generated execution conditions, respectively. The planning unit 221 may, for example, set an interval for each required condition in a parameter file, generate a plurality of execution conditions by varying the values in the interval at predetermined intervals, and prepare an order-receiving plan for each generated execution condition. The conditions to be set include a delivery date, a quantity, and a price, and the like.

For example, if the number of candidates for which the delivery condition is relaxed (delivery extension) is L, the number of candidates for which the quantity condition is relaxed (quantity reduction) is M, and the number of candidates for which the price condition is relaxed (price increase) is N, the planning unit 221 may generate L×M×N combinations of execution conditions.

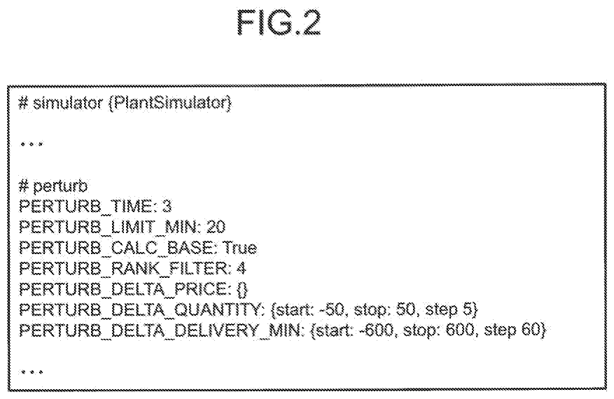

FIG. 2 is an explanatory diagram showing an example of a parameter file. The parameter file illustrated in FIG. 2 shows that the initial values and intervals of parameters to be varied (perturbed) are defined. For example, the start and end of the quantity condition (PERTURB_DELTA_QUANTITY) are set to “−50” and “50”, respectively, indicating that the variation interval is 5.

The first method to generate execution conditions is to use beam search. In beam search, the value of an axis that means a condition is varied only once in one search. The axis that can be varied, the maximum width of the value to be varied, and the tick width of the value to be varied can be predetermined according to the contents of the axis (condition).

The second method to generate the execution conditions is to use grid search. Grid search is a method to search for the most highly evaluated set of parameters by trying all possible combinations of parameters (axes). The method of varying the parameters may be the same as the beam search described above, and the values of multiple axes may be varied simultaneously.

The third method to generate the execution conditions is to the combine beam search and the grid search. In this case, first, the values of axes other than the axis to be varied are fixed, and search is performed by varying only one axis (equivalent to the beam search). After that, the maximum or minimum point is searched, and then the tick width is gradually decreased. Using this method, even if the process is interrupted in the middle, it is possible to generate the execution condition with a certain accuracy.

The fourth method to generate the execution conditions is to probabilistically search for candidates among the execution conditions generated in the past that have not yet been tried. This method can be said that it is a method similar to the Simulated Annealing method and the Genetic Algorithm.

The fifth method to generate the execution conditions is to estimate the bias of the distribution from the history of past execution conditions and to generate detailed candidates according to the bias. This method can be said that it is a method similar to the acquisition function in Bayesian optimization.

The method by which the planning unit 221 prepares an order-receiving plan for execution conditions is arbitrary. For example, the planning unit 221 may prepare the order-receiving plan by generating an optimal production schedule by using a mixed integer programming (MIP) problem.

The planning unit 221 may also prepare an optimal order-receiving plan by manipulating a production model (for example, a factory model) on the simulator using an external script. For example, in the case of optimization by a genetic algorithm, the planning unit 221 may call the optimization module after setting the coefficients of the objective function and the constraint conditions. Also, for example, in the case of performing Bayesian optimization, the planning unit 221 may similarly set the coefficients of the objective function and the constraint conditions, and then call the simulation execution process for obtaining the evaluation values.

When preparing an order-receiving plan, the planning unit 221 may prepare an order-receiving plan within the scope of resources that can be received at present, or may prepare an order-receiving plan that includes changes to orders that have already been received (existing orders), as described below.

The planning unit 221 may divide one order into a plurality of orders and prepare the order-receiving plan. For example, the planning unit 221 may divide one order in terms of quantity and prepare the order-receiving plan.

In addition, the planning unit 221 may have parts composition information (also called BOM (Bill of Materials)/BOP (Bill of Process)) for manufacturing the product, and may prepare a plan concerning the parts composition using the parts composition information at the same time as the order-receiving plan. The plan concerning the parts composition is, for example, a manufacturing plan of parts or a purchase plan of parts.

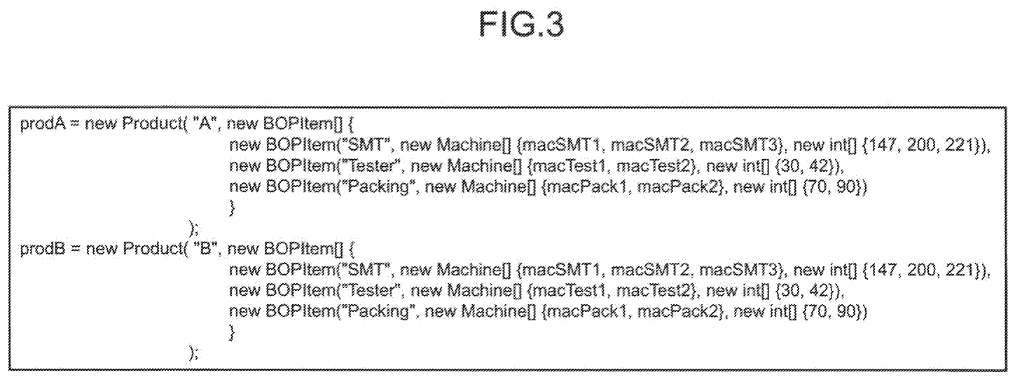

FIG. 3 is an explanatory diagram showing an example of BOM/BOP. FIG. 3 shows that the manufacturing of product A consists of an SMT process, a Tester process, and a Packing process. FIG. 3 also shows that the SMT process can be performed on either a macSMT1 machine, a macSMT2 machine, or a macSMT3 machine.

FIG. 3 also defines that the time taken to perform the SMT process on a macSMT1 machine is 147 seconds, the time taken to perform the SMT process on a macSMT2 machine is 200 seconds, and the time taken to perform the SMT process on a macSMT3 machine is 221 seconds.

The planning unit 221 may also take into account the setup change time, which is the time taken to switch the products to be worked on the same line, and prepare the order-receiving plan so that the total setup change time is minimized. The setup change time is defined, for example, using a function f as f (previous work on the same line, next work on the same line).

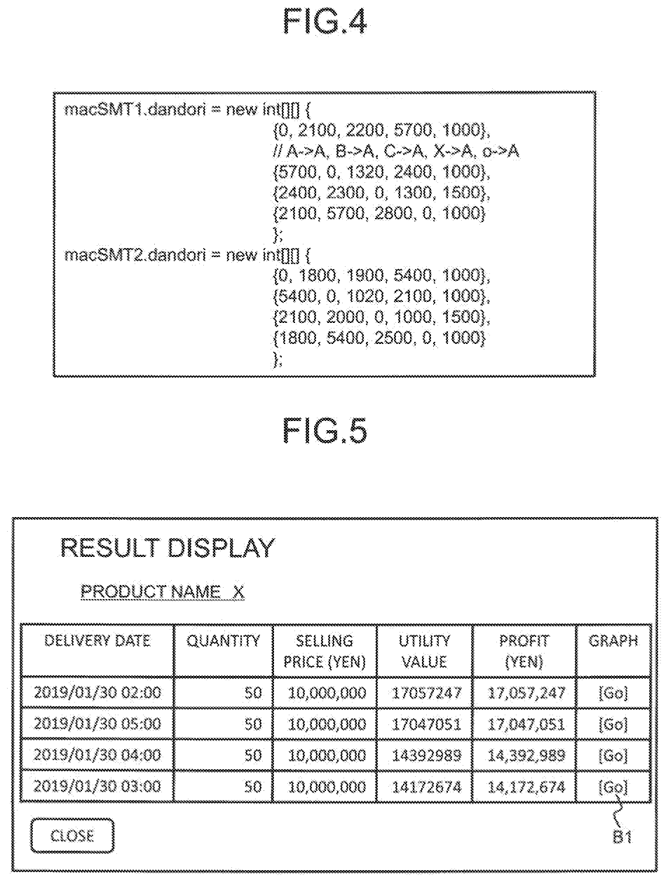

FIG. 4 is an explanatory diagram showing an example of the setup change time. FIG. 4 shows that, for example, when the product to be worked on in a macSMT1 machine is switched from product B to product A, i.e., the setup change from product B to product A takes 2100 seconds.

In addition, resources such as personnel are required for executing a setup change. In addition, there may be restrictions, such as the number of manufacturing devices that can simultaneously perform a setup change is limited to N (where N is a natural number greater than or equal to 2).

Therefore, the planning unit 221 may compute the setup change time so that the resources used for the setup change do not exceed the upper limit. For example, if there are more than N manufacturing devices that perform a setup change at the same time, the planning unit 221 may compute the setup change time so that the manufacturing devices in excess of N perform the setup change after the other manufacturing devices have completed the setup change.

The setup changes that can be performed by each personnel are limited according to the skills possessed by each personnel. For example, worker P1 can perform a setup change from product B to product A, but cannot perform a setup change from product B to product X. Also, worker P2 can perform a setup change from product B to product X, but cannot perform a setup change from product B to product A.

Therefore, the planning unit 221 may compute the setup change time based on the definition of the skills possessed by each personnel.

The utility computation unit 222 computes a utility based on the order-receiving plan. Specifically, the utility computation unit 222 computes the utility using a utility function that computes the degree of favoritism of the order-receiving side for the order-receiving plan. The utility function is represented, for example, by Equation 1 illustrated below.

$$\begin{matrix}[ Math . 1 ] & \\ U = \sum {p}_{i} - λ \sum f ( {x}_{i} , {l}_{i} , {d}_{i} ) - \sum {c}_{i} {υ}_{i} - \sum {m}_{j} {t}_{j} - n ϕ \sum {b}_{k} - θ \sum {h}_{k} - ρ \sum {g}_{j} - \sum {η}_{j} {θ}_{j} where & ( Equation 1 )\end{matrix}$$

$$f ( {x}_{i} , {l}_{i} , {d}_{i} ) = \{ \begin{matrix}0 & ( {l}_{i} - {d}_{i} ≦ 0 ) \\ {x}_{i} ( \begin{matrix}( {l}_{i} - {d}_{i} ) + log \\ ( 1 + exp ( - ( {l}_{i} - {d}_{i} ) ) )\end{matrix} ) & ( {l}_{i} - {d}_{i} > 0 )\end{matrix}$$

In Equation 1, pᵢ is the price of case i (selling price), and the higher the price, the higher the utility. λ∈R⁺is a hyperparameter, xᵢ is the fine of the case i, 1ᵢ, is the production completion time of the case i, and dᵢ is the delivery date of the case i. In other words, 1ᵢ-dᵢ denotes the delivery date violation time. This indicates that the utility decreases as the delivery date is exceeded. In addition, cᵢ indicates the direct material cost per product of the case i, and vᵢ indicates the quantity of the case i, and as this value increases, the production cost increases, and the utility decreases.

In addition, mⱼ indicates an operating cost per second of a machine j, and tⱼ indicates the total operating time (seconds) of the machine j, and as this value increases, the cost required for operation increases, and the utility decreases. κ is the weight specified by the user, and φ indicates the staying cost per product per second of the buffer, bₖ indicates the average number of staying products per second in buffer k. This is because the more products to be stayed, the higher the cost, and the larger this value, the lower the utility.

In addition, θ indicates the staying cost per maximum staying amount of a buffer, and hₖ indicates the maximum staying amount of a buffer k, and as this value increases, the cost in the buffer increases, and the utility decreases. In addition, ρ indicates the cost per second of machine free time, and gⱼ indicates free time (seconds) of machine j, and as this value increases, the utility decreases due to the loss caused by the machine not being in operation. In addition, ηⱼ indicates the start-up cost per day of the machine j, and sⱼ indicates the number of used days of the machine j, and as this value increases, the utility decreases because the cost required to use the machine increases.

Equation 1 above is an example of a utility function, and the content of the function is arbitrary as long as it is a function that can evaluate the desirability of the order-receiving side to the order-receiving plan. For example, a utility function in which only the terms to be considered are selected among the terms included in Equation 1 above may be used.

The negotiation candidate registration unit 223 generates execution conditions as negotiation candidates, which are preconditions for an order-receiving plan regarding an order from the order-placing side. In addition, the negotiation candidate registration unit 223 registers the generated negotiation candidates corresponding to the utility to be computed based on the order-receiving plan in the negotiation candidate storage unit 230. Since these execution conditions are candidates to be presented in negotiations with the order-placing side, they can be called negotiation candidates. This facilitates comparison of utilities among execution conditions because the execution conditions and utilities are corresponded to each other.

The determination unit 224 has a function to determine whether the existing order can be re-planned. Specifically, the determination unit 224 determines whether the execution conditions according to the existing order from the order-placing side can be changed.

For example, the determination unit 224 determines whether the delivery date indicated by the execution condition according to the existing order can be extended when a new order is received. As a concrete example, the determination unit 224 determines whether the delivery date indicated by the execution condition according to the existing order is set earlier than the delivery date specified by the order-placing side.

If the delivery date indicated by the execution condition according to an existing order is set earlier than the delivery date specified by the order-placing side due to a reason such as that the order-receiving side voluntarily set the delivery date earlier, the determination unit 224 determines that the delivery date indicated by the execution condition can be extended.

The determination unit 224 determines whether the order quantity indicated by the execution condition according to the existing order can be reduced when a new order is received. As a specific example, the determination unit 224 determines whether the order quantity indicated by the execution condition according to the existing order is set to be more than the order quantity specified by the order-placing side.

If the order quantity indicated by the execution condition according to an existing order is set to be larger than the order quantity specified by the order-placing side due to a reason such as the order-receiving side voluntarily setting a larger quantity, the determination unit 224 determines that the order quantity indicated by the execution condition can be reduced.

If the order-receiving side has a contract with the order-placing side under which the order-receiving side bears a penalty if an execution condition according to an existing order is changed, the determination unit 224 determines that more execution conditions can be changed. As an example of the setting of the penalty, a setting in which the order-receiving side pays 1% of the price to the order-placing side if the delivery of the product is delayed by one day from the delivery date specified by the order-placing side is considered.

In the case where the order-receiving side has a contract with the order-placing side under which the order-receiving side bears a penalty, the determination unit 224 determines that even if the delivery date indicated by the execution condition according to an existing order is set as the delivery date specified by the order-placing side, the delivery date indicated by the execution condition to be able to be extended.

Even if the order quantity indicated by the execution condition according to the existing order is set as the order quantity specified by the order-placing side, the determination unit 224 determines that the order quantity indicated by the execution condition can be reduced.

In addition, the determination unit 224 includes cancellation of the existing order itself as an option. That is, the determination unit 224 also determines whether the execution condition according to the existing order can be deleted.

The following, a case in which a new order, an order for product X, is received and the determination unit 224 determines that among existing orders, each execution condition of the orders for products A, B, and C can be changed, is considered as an example.

If it is determined that each execution condition of the orders for products A, B, and C can be changed, the planning unit 221 treats the orders for products A, B, and C as operation variables, and prepares an order-receiving plan again for the case where an order for product X is received, including the resources scheduled for the orders for products A, B, and C.

The planning unit 221 prepares an order-receiving plan when each execution condition of the orders for products A, B, and C are changed, respectively. In other words, the planning unit 221 prepares an order-receiving plan for execution conditions according to a new order from the order-placing side and execution conditions according to an existing order, after changing the execution conditions that are determined to be changeable.

Next, the utility computation unit 222 computes a utility based on the re-prepared order-receiving plan. Then, the negotiation candidate registration unit 223 registers the execution conditions that are preconditions for the re-prepared order-receiving plan as negotiation candidates corresponding to the utility computed based on the order-receiving plan, in the negotiation candidate storage unit 230.

In the case where the above-described order-receiving side has a contract with the order-placing side under which the order-receiving side bears a penalty, the utility computation unit 222 integrates the utility based on the re-prepared order-receiving plan and the utility corresponding to the penalty associated with the change in execution conditions to compute the utility of the entire order-receiving plan.

If the execution conditions of a new order are more favorable to the order-receiving side than the execution conditions of an existing order, the planning unit 221 can prepare an order-receiving plan with higher utility. In other words, the order-receiving side negotiation system 200 can prevent the order-receiving side from losing orders that are more favorable order to the order-receiving side.

If a change flag that means whether each order including the existing orders can be changed can be recorded in the prepared order-receiving plan, the determination unit 224 may determine that the execution conditions according to the existing orders for which the change flag is set can be changed. Also, the determination unit 224 may determine that the execution condition according to the existing order for which the acceptance of the change is obtained from the order-placing side can be changed.

The negotiation candidate storage unit 230 stores a plurality of negotiation candidates (i.e., combinations of execution conditions and utilities). The negotiation candidate storage unit 230 is realized, for example, by a magnetic disk.

The negotiation candidate sending unit 240 sends to the order-placing side a corresponding negotiation candidate stored in the negotiation candidate storage unit 230 for the received negotiation condition (order). For example, when a negotiation candidate based on an execution condition that matches the negotiation condition is stored in the negotiation candidate storage unit 230, the negotiation candidate sending unit 240 may send to the order-placing side the negotiation candidate with the highest utility among the negotiation candidates. Also, for example, if no negotiation candidate based on an execution condition that matches the negotiation condition is stored in the negotiation candidate storage unit 230, the negotiation candidate sending unit 240 may send to the order-placing side the negotiation candidate of the order-receiving plan that has the high utility priority among the negotiation candidates based on the execution condition that has many matching negotiation conditions.

The negotiation candidate management unit 250 manages the negotiation candidates stored in the negotiation candidate storage unit 230. The negotiation candidate management unit 250 has a negotiation candidate display unit 251 and a negotiation candidate update unit 252.

The negotiation candidate display unit 251 displays the negotiation candidates stored in the negotiation candidate storage unit 230. The negotiation candidate display unit 251 may, for example, limit the display to negotiation candidates that correspond to the specified conditions. FIG. 5 is an explanatory diagram showing an example of displaying a negotiation candidate. In the example shown in FIG. 5, the negotiation candidate display unit 251 displays a list in which a delivery date, a quantity, a selling price (in yen), a utility value, and a profit (in yen) are associated as negotiation candidates for a product whose product name is “X”.

Further, the negotiation candidate display unit 251 may display details of a corresponding order-receiving plan for realizing the negotiation candidate. The negotiation candidate display unit 251 may, for example, as illustrated in FIG. 5, provide a button B1 instructing a transition to a screen that displays a graph (for example, a manufacturing line operation plan Gantt chart, etc.) showing an order-receiving plan for each negotiation candidate to display more detailed information.

The negotiation candidate update unit 252 updates the contents of the negotiation candidates stored in the negotiation candidate storage unit 230. The negotiation candidate update unit 252 may, for example, delete a negotiation candidate that is determined to be inappropriate based on a user's instruction.

The negotiation condition receiving unit 210, the negotiation candidate generation unit 220 (more particularly, the planning unit 221, the utility computation unit 222, the negotiation candidate registration unit 223 and the determination unit 224), the negotiation candidate sending unit 240, and the negotiation candidate management unit 250 (more particularly, the negotiation candidate display unit 251 and the negotiation candidate update unit 252) is realized by a computer processor (for example, CPU (Central Processing Unit), GPU (Graphics Processing Unit)) that operates according to a program (negotiation program).

For example, the program is stored in a storage unit (not shown) included in the order-receiving side negotiation system 200, and the processor reads the program and, according to the program, and may operate as the negotiation condition receiving unit 210, the negotiation candidate generation unit 220 (more particularly, the planning unit 221, the utility computation unit 222, the negotiation candidate registration unit 223 and the determination unit 224), the negotiation candidate sending unit 240 and the negotiation candidate management unit 250 (more particularly, the negotiation candidate display unit 251 and the negotiation candidate update unit 252)). Also, the functions of the order-receiving side negotiation system 200 may be provided in a SaaS (Software as a Service) format.

The negotiation condition receiving unit 210, the negotiation candidate generation unit 220 (more particularly, the planning unit 221, the utility computation unit 222, the negotiation candidate registration unit 223 and the determination unit 224), the negotiation candidate sending unit 240, and the negotiation candidate management unit 250 (more particularly, the negotiation candidate display unit 251 and the negotiation candidate update unit 252) may each be realized by dedicated hardware. In addition, some or all of the components of each of the devices may be realized by general-purpose or dedicated circuitry, processors, or a combination thereof These may comprise a single chip or a plurality of chips connected through a bus. Some or all of the components of each device may be realized by a combination of the above-described circuits, etc. and a program.

In the case where some or all of each component of the order-receiving side negotiation system 200 is realized by a plurality of information processing device, circuits, or the like, the plurality of information processing device, circuits, or the like may be centrally arranged or distributed. For example, the information processing device, circuits, and the like may be implemented as a client-server system, a cloud computing system, and the like, each of which is connected through a communication network.

The order-placing side negotiation system 100 includes the negotiation condition input unit 110, the negotiation condition sending unit 120, the negotiation candidate receiving unit 130, and the result display unit 140.

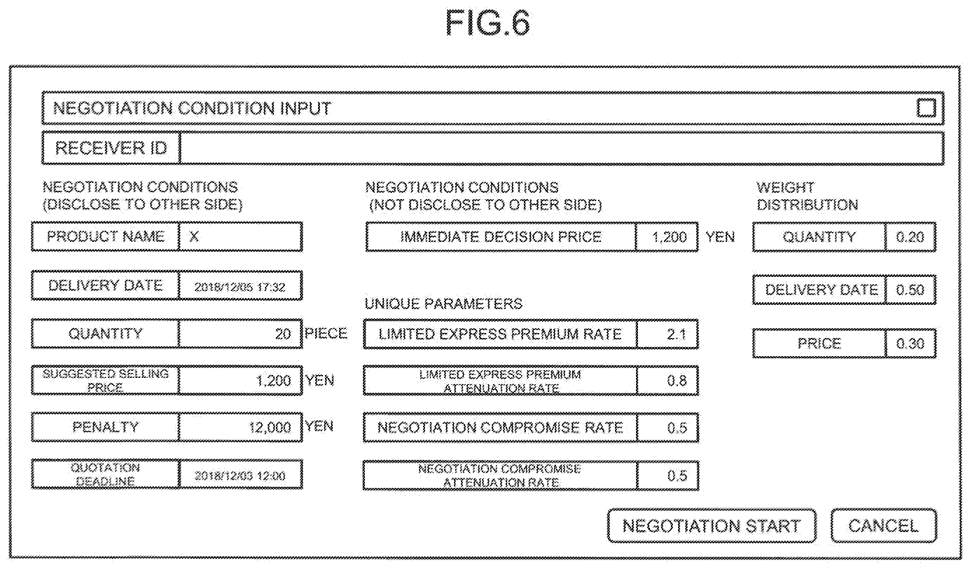

The negotiation condition input unit 110 receives the input of various negotiation conditions from the order-placing side. FIG. 6 is an explanatory diagram showing an example of a screen for entering a negotiation condition. The example shown in FIG. 6 illustrates a screen for inputting negotiation conditions to be disclosed to the other side (the order-receiving side) and negotiation conditions not to be disclosed to the other side. The negotiation conditions not to be disclosed to the other side are used, for example, when a decision on whether to agree or not to a negotiation candidate presented by the order-receiving side is automatically made.

The negotiation condition sending unit 120 sends the inputted negotiation conditions to the order-receiving side negotiation system 200. The negotiation condition sending unit 120 may, for example, limit the send to the negotiation conditions disclosed to the other side among the negotiation conditions illustrated in FIG. 6.

The negotiation candidate receiving unit 130 receives a negotiation candidate for the sent negotiation conditions from the order-receiving side negotiation system 200. The negotiation candidate receiving unit 130 determines whether the negotiation candidate satisfies the predetermined criteria, and if the criteria are satisfied, the negotiation candidate receiving unit 130 may automatically send an agreement to the order-receiving side negotiation system 200. For example, when the immediate decision price of the negotiation condition illustrated in FIG. 6 is received as a negotiation candidate, the negotiation candidate receiving unit 130 may send a message to the effect that it is an agreement to the order-receiving side negotiation system 200.

The conditions for determining whether agreement is reached are not limited to the price illustrated in FIG. 6. For example, a utility function for computing the degree of favoritism of the order-placing side may be predetermined even on the order-placing side, and the negotiation candidate receiving unit 130 may determine that it is an agreement when the utility computed based on the utility function exceeds a predetermined threshold.

The result display unit 140 displays the contents of the received negotiation candidates. In the case that an automatic negotiation is conducted, the result display unit 140 may display the content of the concluded negotiation.

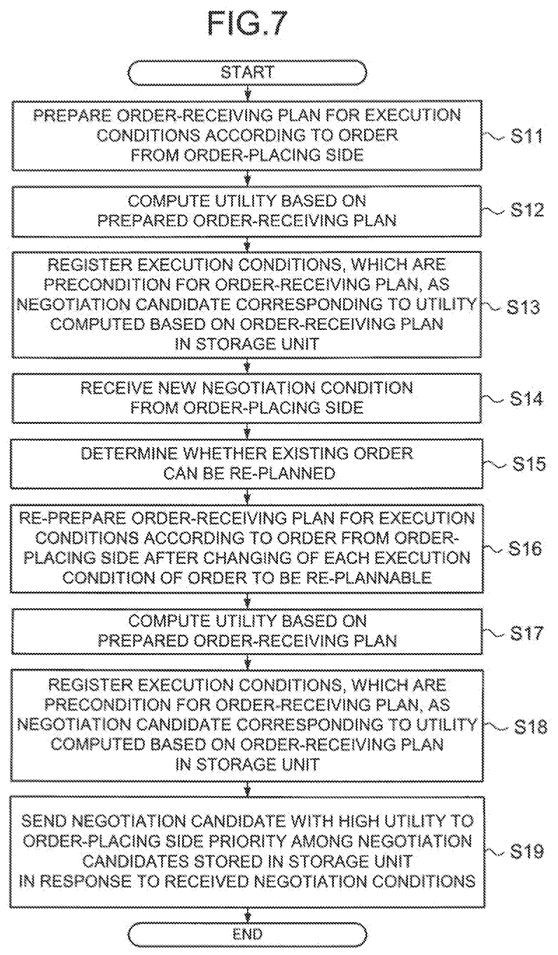

Next, the operation of the negotiation system of this example embodiment will be described. FIG. 7 is a flowchart showing an example of the operation by the automated negotiation system 10 (order-receiving side negotiation system 200) of this example embodiment.

First, the planning unit 221 of the order-receiving side negotiation system 200 prepares an order-receiving plan for execution conditions according to the order from the order-placing side (step S11). The utility computation unit 222 computes a utility based on the prepared order-receiving plan (step S12). The negotiation candidate registration unit 223 registers the execution conditions, which are a precondition of the order-receiving plan, as negotiation candidates corresponding to the utility computed based on the order-receiving plan, in the negotiation candidate storage unit 230 (step S13).

Thereafter, the negotiation conditions input to the negotiation condition input unit 110 of the order-placing side negotiation system 100 are sent by the negotiation condition sending unit 120, and the negotiation condition receiving unit 210 receives the new negotiation conditions from the order-placing side (order-placing side negotiation system 100) (step S14).

Next, the determination unit 224 determines whether the re-planning of the existing order is possible (Step S15). Then, the planning unit 221 changes each execution condition of the order that is determined to be re-plannable, and re-prepares the order-receiving plan for the execution condition according to the order from the order-placing side (Step S16). Next, the utility computation unit 222 computes a utility based on the re-prepared order-receiving plan (Step S17).

The negotiation candidate registration unit 223 registers the execution conditions that are preconditions for the re-prepared order-receiving plan as negotiation candidates corresponding to the utility computed based on the order-receiving plan, in the negotiation candidate storage unit 230 (Step S18).

In response to the received negotiation conditions, the negotiation candidate sending unit 240 sends to the order-placing side the negotiation candidates with the high utility priority among the negotiation candidates stored in the negotiation candidate storage unit 230 (Step S19). Then, the negotiation candidate receiving unit 130 of the order-placing side negotiation system 100 receives the sent negotiation candidates.

As described above, in this example embodiment, the planning unit 221 prepares an order-receiving plan for execution conditions in response to an order from the order-placing side, the utility computation unit 222 computes a utility based on the order-receiving plan, and the negotiation candidate registration unit 223 registers an execution condition that is a precondition of the order-receiving plan as a negotiation candidate corresponding to the utility computed based on the order-receiving plan in the negotiation candidate storage unit 230. Then, the negotiation candidate sending unit 240, in response to the received negotiation conditions, sends to the order-placing side the negotiation candidates with the high utility priority among the negotiation candidates stored in the negotiation candidate storage unit 230.

The determination unit 224 determines whether the re-planning of an existing order is possible when a new order is received. The planning unit 221 re-prepares the order-receiving plan after changing each execution condition of the order that is determined to be able to be re-planned. By re-preparing the order-receiving plan, the planning unit 221 can reallocate resources that have been allocated to relatively low-value orders to high-value orders. In other words, the order-receiving side negotiation system 200 of this example embodiment can provide the order-receiving side with an opportunity to receive an order of higher value even when the available resources are limited.

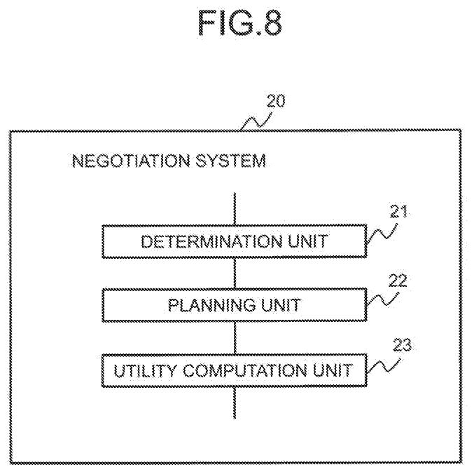

Next, an overview of the present invention will be described. FIG. 8 is a block diagram showing an overview of the negotiation system according to the present invention. A negotiation system 20 (for example, the order-receiving side negotiation system 200) according to the present invention is a negotiation system for negotiating with an order-placing side who presents, to an order-receiving side that provides any product or service, an order that represents a request for provision of the any product or service, includes a determination unit 21 (for example, the determination unit 224) which determines whether execution conditions according to an existing order from the order-placing side can be changed, a planning unit 22 (for example, the planning unit 221) which prepares an order-receiving plan for execution conditions according to a new order from the order-placing side and execution conditions according to the existing order after changing of an execution condition determined to be changeable, and a utility computation unit 23 (for example, the utility computation unit 222) which computes a utility based on the order-receiving plan.

With such a configuration, the negotiation system can provide the order-receiving side with an opportunity to receive a higher value order.

The negotiation system 20 may include a negotiation candidate generation unit (for example, the negotiation candidate generation unit 220) which generates an execution condition, which is a precondition for an order-receiving plan regarding an order from an order-placing side as a negotiation candidate, and a negotiation candidate sending unit (for example, the negotiation candidate sending unit 240) which sends a negotiation candidate of the order-receiving plan with high utility in priority to the order-placing side with respect to the order.

With such a configuration, the negotiation system can provide the order-receiving side with an opportunity to receive a higher value order.

The determination unit 21 may determine whether a delivery date indicated by the execution condition according to the existing order can be extended. The determination unit 21 may determine whether an order quantity indicated by the execution condition according to the existing order can be reduced. The execution conditions may include a delivery date, a quantity, and a price. The determination unit 21 may determine whether the execution condition according to the existing order can be deleted.

The determination unit 21 may determine that the execution condition according to the existing order for which a change flag is set can be changed. The determination unit 21 may determine that the execution condition according to the existing order for which an acceptance of the change is obtained from the order-placing side can be changed.

With such a configuration, the negotiation system can change existing orders that can be changed.

Some or all of the aforementioned example embodiment can be described as supplementary notes mentioned below, but are not limited to the following supplementary notes.

(Supplementary note 1) A negotiation system for negotiating with an order-placing side who presents, to an order-receiving side that provides any product or service, an order that represents a request for provision of the any product or service, comprising: a determination unit which determines whether execution conditions according to an existing order from the order-placing side can be changed; a planning unit which prepares an order-receiving plan for execution conditions according to a new order from the order-placing side and execution conditions according to the existing order after changing of an execution condition determined to be changeable; and a utility computation unit which computes a utility based on the order-receiving plan.

(Supplementary note 2) The negotiation system according to Supplementary note 1, further comprising: a negotiation candidate generation unit which generates an execution condition, which is a precondition for an order-receiving plan regarding an order from an order-placing side as a negotiation candidate; and a negotiation candidate sending unit which sends a negotiation candidate of the order-receiving plan with high utility in priority to the order-placing side with respect to the order.

(Supplementary note 3) The negotiation system according to Supplementary note 1 or 2, wherein the determination unit determines whether a delivery date indicated by the execution condition according to the existing order can be extended.

(Supplementary note 4) The negotiation system according to any one of Supplementary notes 1 to 3, wherein the determination unit determines whether an order quantity indicated by the execution condition according to the existing order can be reduced.

(Supplementary note 5) The negotiation system according to any one of Supplementary notes 1 to 4, wherein the determination unit determines whether the execution condition according to the existing order can be deleted.

(Supplementary note 6) The negotiation system according to any one of Supplementary notes 1 to 5, wherein the determination unit determines that the execution condition according to the existing order for which a change flag is set can be changed.

(Supplementary note 7) The negotiation system according to any one of Supplementary notes 1 to 5, wherein the determination unit determines that the execution condition according to the existing order for which an acceptance of the change is obtained from the order-placing side can be changed.

(Supplementary note 8) The negotiation system according to any one of Supplementary notes 1 to 7, wherein the planning unit generates a plurality of execution condition based on the order, and prepares the order-receiving plans for the generated execution conditions respectively.

(Supplementary note 9) The negotiation system according to any one of Supplementary notes 1 to 8, wherein the planning unit generates a plurality of execution condition by varying a value in the interval for each required condition at predetermined intervals, and prepares the order-receiving plans for each generated execution condition.

(Supplementary note 10) The negotiation system according to any one of Supplementary notes 1 to 9, wherein the utility computation unit computes a utility using a utility function that computes a degree of favoritism of the order-receiving side with respect to the order-receiving plan.

(Supplementary note 11) The negotiation system according to any one of

Supplementary notes 1 to 10, wherein the planning unit prepares an optimal order-receiving plan by processing using a simulator with an optimization engine.

(Supplementary note 12) The negotiation system according to any one of Supplementary notes 1 to 11, wherein the execution conditions include a delivery date, a quantity, and a price.

(Supplementary note 13) A negotiation method implemented by a negotiation system for negotiating with an order-placing side who presents, to an order-receiving side that provides any product or service, an order that represents a request for provision of the any product or service, comprising: determining whether execution conditions according to an existing order from the order-placing side can be changed; preparing an order-receiving plan for execution conditions according to a new order from the order-placing side and execution conditions according to the existing order after changing of an execution condition determined to be changeable; and computing a utility based on the order-receiving plan.

(Supplementary note 14) The negotiation method according to Supplementary note 13, further comprising: generating an execution condition, which is a precondition for an order-receiving plan regarding an order from an order-placing side as a negotiation candidate; and sending a negotiation candidate of the order-receiving plan with high utility in priority to the order-placing side with respect to the order.

(Supplementary note 15) A negotiation program causing a computer to execute: a determination process of determining whether execution conditions according to an existing order from an order-placing side that represents a request for provision of any product or service to an order-receiving side that provides the any product or service can be changed; a preparing process of preparing an order-receiving plan for execution conditions according to a new order from the order-placing side and execution conditions according to the existing order after changing of an execution condition determined to be changeable; and a computation process of computing a utility based on the order-receiving plan.

(Supplementary note 16) The negotiation program according to Supplementary note 15, causing the computer to execute: a generation process of generating an execution condition, which is a precondition for an order-receiving plan regarding an order from an order-placing side as a negotiation candidate; and a sending process of sending a negotiation candidate of the order-receiving plan with high utility in priority to the order-placing side with respect to the order.

While the present invention has been explained with reference to the example embodiments, the present invention is not limited to the aforementioned example embodiments. Various changes understandable to those skilled in the art within the scope of the present invention can be made to the structures and details of the present invention.

### INDUSTRIAL APPLICABILITY

The present invention is suitably applied to an order-placing/receiving support method or a negotiation method which efficiently automates or semi-automates negotiations between an order-placing side and an order-receiving side related to such as a delivery date, a quantity, or a price.

### REFERENCE SIGNS LIST

10 Automated negotiation system

20 Negotiation system

21, 224 Determination unit

22, 221 Planning unit

23, 222 Utility computation unit

100 Order-placing side negotiation system

110 Negotiation condition input unit

120 Negotiation condition sending unit

130 Negotiation candidate receiving unit

140 Result display unit

200 Order-receiving side negotiation system

210 Negotiation condition receiving unit

220 Negotiation candidate generation unit

223 Negotiation candidate registration unit

230 Negotiation candidate storage unit

240 Negotiation candidate sending unit

250 Negotiation candidate management unit

251 Negotiation candidate display unit

252 Negotiation candidate update unit

What is claimed is:

1. A negotiation system, comprising:
a processor; and
a memory storing a program executed by the processor;
the program including steps of:
determining whether execution conditions according to an existing order from the an order-placing side can be changed; changed, the order-placing side presenting an order request for provision of at least one of products or services to an order-receiving side providing at least one of products or services;
preparing an order-receiving plan for execution conditions according to a new order from the order-placing side and execution conditions according to the existing order after changing of an execution condition determined to be changeable; and
computing a utility based on the order-receiving plan.

2. The negotiation system according to claim 1, further comprising: wherein
the program including steps of:
generating an execution condition, which is a precondition for an order-receiving plan regarding an order from an order-placing side as a negotiation candidate; and
sending a negotiation candidate of the order-receiving plan with high utility in priority to the order-placing side with respect to the order.

3. The negotiation system according to claim 1, wherein
the program including step of determining whether a delivery date indicated by the execution condition according to the existing order can be extended.

4. The negotiation system according to claim 1, wherein
the program including step of determining whether an order quantity indicated by the execution condition according to the existing order can be reduced.

5. The negotiation system according to claim 1, wherein
the program including step of determining whether the execution condition according to the existing order can be deleted.

6. The negotiation system according to claim 1, wherein
the program including step of determining that the execution condition according to the existing order for which a change flag is set can be changed.

7. The negotiation system according to claim 1, wherein
the program including step of determining that the execution condition according to the existing order for which an acceptance of the change is obtained from the order-placing side can be changed.

8. A negotiation method implemented by a negotiation system, comprising:
determining whether execution conditions according to an existing order from the an order-placing side can be changed, the order-placing side presenting an order request for provision of at least one of products or services to an order-receiving side providing at least one of products or services;
preparing an order-receiving plan for execution conditions according to a new order from the order-placing side and execution conditions according to the existing order after changing of an execution condition determined to be changeable; and
computing a utility based on the order-receiving plan.

9. The negotiation method according to claim 8, further comprising:
generating an execution condition, which is a precondition for an order-receiving plan regarding an order from an order-placing side as a negotiation candidate; and
sending a negotiation candidate of the order-receiving plan with high utility in priority to the order-placing side with respect to the order.

10. A non-transitory computer-readable recording medium recording a negotiation program causing a computer to execute:
a determination process of determining whether execution conditions according to an existing order from an order-placing side that represents a request for provision of any product or service to an order-receiving side that provides the any product or service can be changed;
a preparing process of preparing an order-receiving plan for execution conditions according to a new order from the order-placing side and execution conditions according to the existing order after changing of an execution condition determined to be changeable; and
a computation process of computing a utility based on the order-receiving plan.

11. The recording medium according to claim 10, causing the computer to execute:
a generation process of generating an execution condition, which is a precondition for an order-receiving plan regarding an order from an order-placing side as a negotiation candidate; and
a sending process of sending a negotiation candidate of the order-receiving plan with high utility in priority to the order-placing side with respect to the order.

12. The negotiation system according to claim 2, wherein
the program including step of determining whether a delivery date indicated by the execution condition according to the existing order can be extended.

13. The negotiation system according to claim 2, wherein
the program including step of determining whether an order quantity indicated by the execution condition according to the existing order can be reduced.

14. The negotiation system according to claim 3, wherein
the program including step of determining whether an order quantity indicated by the execution condition according to the existing order can be reduced.

15. The negotiation system according to claim 12, wherein
the program including step of determining whether an order quantity indicated by the execution condition according to the existing order can be reduced.

16. The negotiation system according to claim 1, wherein
the program including steps of:
generating a plurality of execution condition based on the order; and
preparing the order-receiving plans for the generated execution conditions respectively.

17. The negotiation system according to claim 1, wherein
the program including steps of:
generating a plurality of execution condition by varying a value in the interval for each required condition at predetermined intervals; and
preparing the order-receiving plans for each generated execution condition.

18. The negotiation system according to claim 1, wherein
the program including step of computing a utility using a utility function that computes a degree of favoritism of the order-receiving side with respect to the order-receiving plan.

19. The negotiation system according to claim 1, wherein
the program including step of preparing an optimal order-receiving plan by processing using a simulator with an optimization engine.

20. The negotiation system according to claim 1, wherein
the execution conditions include a delivery date, a quantity, and a price.
